(19) United States
(12) Patent Application Publication
(10) Pub. No.: US 2001/0037388 A1
(43) Pub. Date: Nov. 1, 2001

(54) Method and apparatus for communicating with network from comunication terminal

(75) Inventor: Shinichiro Suzuki, Chigasaki-shi (JP)

Correspondence Address: Louis P. Herzberg, IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY (US)

(21) Appl. No.: 09/818,795

(22) Filed: Mar. 27, 2001

(30) Foreign Application Priority Data
Mar. 31, 2000 (JP) 2000-098818

(51) Int. Cl. G06F 15/173

(52) U.S. Cl. 709/225

(57) ABSTRACT

Provides a portable telephone enabled to communicate with a network according to the identification result of identification information and a password thereof so as to prevent an illegal use of a copy telephone manufactured with a stolen password. A communication method and apparatus of the present invention comprises the steps of: (a) sending both identification information and password stored in a non-volatile memory of a portable telephone to a network at the start of a communication; (b) generating a new password before the end of the communication, the new password being different from that sent in the step (a); (c) storing the generated password in the non-volatile memory of the portable telephone; and (d) sending the generated password to the network before the end of the communication, which is started in the step (a). Because the password is updated automatically in each communication, illegal use of a copy telephone can be prevented.

### DETAILED DESCRIPTION OF THE INVENTION

1. Field of the Invention

The present invention relates to a communication terminal enabled to communicate with a network on a condition that both identification information and password thereof are identified, more particularly to a technique that prevents a copy communication terminal from an attempt of illegal accessing said network by detecting the illegal accessing easily. The illegal accessing uses identification information and a password that are stolen from the terminal.

2. Background Art

In recent years, portable telephones are getting popular and popular because of their convenience that they can be brought about freely from place to place. Each of those portable telephone is assigned with an identification number and a phone number specific thereto upon the contract by a communication service provider. Both of the identification number and the phone number are stored in the internal memory of the telephone. When a communication is started, the remote phone number is sent together with both of the phone number and the identification information to the subject base station so as to be collated with the contractor information registered in the base station beforehand. And, when both match, the phone is connected to the remote phone number, thereby the communication time is calculated for accounting. In case the identification information and the phone number are stolen and set in another portable telephone and the telephone is used, the accounting is done on the basis of the identification information, thereby the normal owner of the telephone comes to suffer the damage. Especially, because such portable telephones use a radio wave so as to send both phone number and identification information respectively, those information items are easily stolen; even when those items are encrypted, they are always exposed to a peril of being decrypted and used illegally.

Consequently, the identification number of each portable telephone is devised so as not to be stolen and the user is permitted to have only one portable telephone having an identification number and a phone number corresponding to the identification number under one contraction. Published Unexamined Patent Application No. 8-340579 discloses such a technique that prevents a portable telephone from a fraudulent use. In the case of a conventional portable telephone, the subscriber's number, mobile station number, and identification information including both certification and secret key are scrambled by a scramble code and the scrambled identification information is stored in the non-volatile RAM of the control section of the telephone, which includes a CPU. And, the initial value of the scramble code is stored in the ROM of the control section and the control section is provided with an algorithm that generates the scramble code. In addition, because the initial value of such the scramble code is common to every product, it is easy to copy the content and the algorithm stored in the control section into the control section of another portable telephone, to substantially steal the portable telephone of any person. Consequently, according to the invention disclosed in the above specification, the initial value of a scramble code is set differently in each portable telephone and the identification information is scrambled when it is written in its EEPROM. The identification information is descrambled to be sent when a call is to be made from the telephone.

Published Unexamined Patent Application No. 6-291835 discloses another invention for preventing a portable telephone from being used by any person other than the true owner without the owner's permission when the portable telephone is left behind, stolen, etc. According to this invention, a portable telephone, when its phone number is registered, is connected to a number registration device in which the personal identification number (PIN) code is stored. Then, the user (owner) inputs the PIN code with use of input keys. The phone number is registered in the phone number memory of the portable telephone via a connection terminal only when the inputted PIN code agrees to the code stored in the PIN code memory. And, to use the registered phone number, the user is requested to input the select code of the registered phone number with use of a select key of the portable telephone. Because the portable telephone is enabled to send data only via the registered phone number, the telephone can be prevented from being used without the owner's permission.

And, Published Unexamined Patent Application No. 4-310026 discloses still another technique for preventing an identification number specific to a communication device from being read and used intentionally. According to this technique, such a specific identification number is converted in a predetermined procedure so as to be stored together with an error correction code, thereby preventing the identification number from an illegal use. In addition, when the identification number is read, the data error is corrected and it is converted to the original specific identification number. In case an error correction is further done for the identification number, therefore, the corrected data is stored in the storage, thereby data damages are prevented.

Published Unexamined Patent Application No. 11-146057 discloses a system that can identify the user of a mobile telephone without requesting the user to input his/her password so as to prevent a fraudulent use of the telephone. According to this invention, which is a technique that prevents an illegal use of a stolen or lost portable telephone with fraudulent use of the password, the inventor et al have directed their attention to the inconvenience that the user must learn and input a password and employs such user's physical features as voice, carbon dioxide density at a breathing time, finger print, etc. as an identifier, thereby preventing the user from being charged of a call made in an illegal use of the telephone.

On the other hand, the user is restricted so as to use only one portable telephone under one contract, that is, in case such the accounting information as the identification number and phone number specific to the telephone is identical even when the contractor is one and the same. Therefore, in case a telephone is used separately for business activities and for private activities, the user have had to make two contracts. This has been a problem of the conventional technique. In addition, in case the user wants to use a PDA, a portable PC, etc. provided with communication functions as a communication terminal other than the portable telephone, the user have also had to make a contract for each of those machines separately. And, in order to solve such the problem, Published Unexamined Patent Application No. 10-145523 discloses a technique for using a card that stores a terminal identification number and a technique for enabling a user to use a plurality of communication terminals by sending/receiving a terminal identification number through a communication port while maintaining a condition that assigns one communication terminal per one contract.

Problems to be solved by the invention

There is also a technique for protecting the true owner of a portable telephone from illegal uses to be done when the telephone itself is stolen or only the identification information is used fraudulently so as to be set in another portable telephone. In case a portable telephone is stolen or lost, so that the telephone is away from the true owner, the user, when knowing the fact, can get in contact with the telephone company to stop the use so as to minimize the damage. However, in case the identification number is stolen and set in another telephone so as to make a copy telephone while the owner of the telephone does not know it, the damage might possibly be very great, since the user cannot know the illegal uses of the copy telephone until the user receives an account, which is usually received monthly. Especially, in case a plurality of copy telephones are made, the damage to be caused by illegal uses will become more serious.

And, any of the conventional techniques described above does not guarantee that the initial value of a scramble code is never stolen even when it is set for each telephone; the logic to scramble the code might also be analyzed. And, even when the user is requested to input his/her password, the conventional technique does not guarantee that the password is never stolen. Updating, managing, and inputting such a password are also troublesome.

Furthermore, in case it is enabled to use a plurality of portable telephones or communication terminals selectively under one contract, it means a higher possibility that the telephones are copied illegally. And, any of the conventional techniques described above cannot solve the problem.

### SUMMARY OF THE INVENTION

Under such circumstances, it is an object of the present invention to provide a technique that can easily recognize a fact that a password is stolen and set in another communication terminal, which is then used as a copy terminal. The technique is employed for such a communication terminal as a portable telephone, etc. enabled to communicate with another according to the identification result of identification information and a password thereof. It is another object of the present invention to provide a technique that enables a plurality of communication terminals to be used selectively under one contract while effectively preventing illegal uses of a copy terminals manufactured by a person other than the true owner.

### BRIEF DESCRIPTION OF THE DRAWINGS

These and other aspects, features, and advantages of the present invention will become apparent upon further consideration of the following detailed description of the invention when read in conjunction with the drawing figures, in which:

FIG. 1 is a schematic block diagram of a portable telephone network in an embodiment of the present invention;

FIG. 2 is a schematic block diagram of a portable telephone in an embodiment of the present invention;

FIG. 3 is a block diagram of a ROM 113;

FIG. 4 is a block diagram of a configuration of a non-volatile memory 117;

FIG. 5 is a flowchart for describing the embodiment of the present invention;

FIG. 6 shows an embodiment of a contractor information table;

FIG. 7 shows another embodiment of the present invention; and

FIG. 8 is a flowchart for describing another embodiment of the present invention.

### DETAILED DESCRIPTION OF THE INVENTION

The first embodiment of the present invention is a communication terminal provided with a non-volatile memory that stores identification information and a password thereof and enabled to communicate with a network after the identification information and the password are collated. The identification information and the password may be any codes generated as such electronic information as alphanumerics, symbols, etc. In this embodiment, a new password different from the password having been sent to the network at the start of each communication is generated before the started communication is ended. Because such a new password is generated during each communication, the possibility that the password is stolen becomes lower than when the user updates his/her password as needed. The generated password is stored in the non-volatile memory, so the user is not required to input the password by operating keys each time the user begins a communication. The new password is sent to the network before the communication is ended. The password should preferably be sent together with a communication termination code at the end of the communication. Consequently, both of the communication terminal and the network can hold the new password generated during a communication at the end of the communication, so that the network can enable the communication terminal to start the next communication by collating the new password.

Because such a password is updated for each communication, it is impossible that only a stolen password is used to manufacture a copy terminal and the copy terminal is used continuously while the true user does not know the fact. Concretely, as long as the true user owns and uses his/her normal communication terminal, the password is updated by the true user for each communication. It is thus impossible for any fraudulent user to use the copy terminal unless he/she steals a new password at each communication. In case the fraudulent user updates the password to use the normal communication terminal at each communication just like the true user, the communication is stopped when the normal communication terminal is used because the normal communication terminal cannot access the network with use of the valid password that is recognized by the network at that time. Therefore, the true user can know that his/her password is used fraudulently. The communication terminal may be any of radio and wire terminals or portable and desk-top terminals.

The second embodiment of the present invention is a network managed by a communication service provider. The network enables each communication terminal to begin a communication by comparing the information registered in its storage with both identification information and password of the communication terminal received at the start of the communication. In addition, the network receives a new password that is different from that received at the start of the communication and stores the new password in the storage before ending the communication. Consequently, both of the communication terminal and the network hold the new password, thereby the network compares the identification information and the password sent from the communication terminal at the start of the next communication with those stored in the storage.

The third embodiment of the present invention is first and second communication terminals used for communicating with the network respectively. While only one communication terminal is used under one contract, this embodiment can prevent an illegal use of a copy terminal even when any active one of the communication terminals is selected. Each of the first and second communication terminals is provided with a well-known function for enabling the information stored in the non-volatile memory to be exchanged mutually. The function may be realized by directly connecting a cable to between the mutual communication ports or via the network. In addition, it is also possible that the content in one non-volatile memory is transferred to the other non-volatile storage once, then the content is written in the non-volatile memory of the other communication terminal.

Both identification information and password stored in the first non-volatile memory of the first communication terminal are transferred to and stored in the second non-volatile memory of the second communication terminal. And, the use of the first communication terminal is inhibited, thereby the condition that only one terminal is usable under one contract is secured. The password transferred to the second non-volatile memory is a valid password that is also held in the network at that time. Hereinafter, the second communication terminal can communicate with the network in the same way as that described in the first embodiment. Still another embodiment of the present invention is a communication terminal and a network apparatus that can realize each of the embodiments described above.

Preferred embodiment

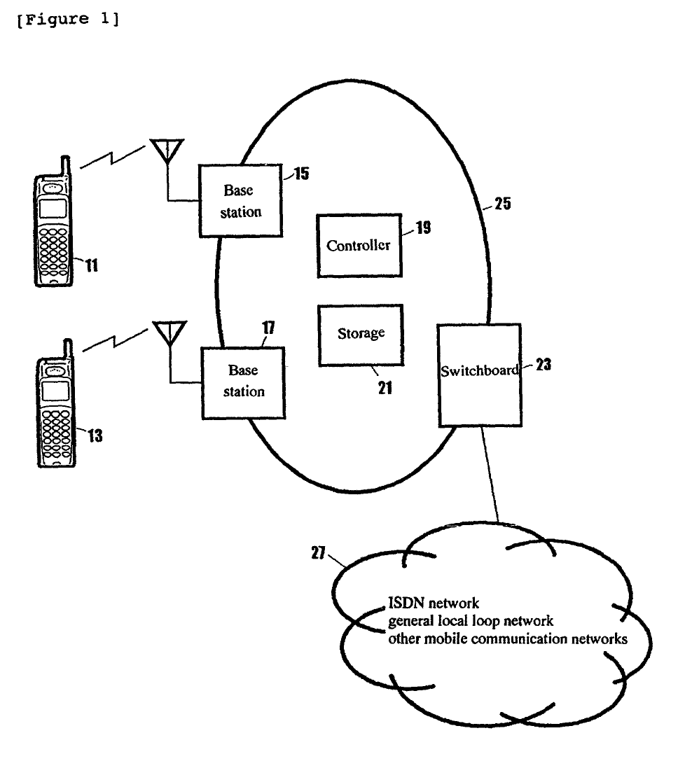

FIG. 1 shows a schematic block diagram of a portable telephone network in an embodiment of the present invention. A portable telephone network 25 supplied by a telephone connection company includes base stations 15 and 17 for sending/receiving and processing radio signals; a controller 19 for selecting a base station to which each portable telephone is connected, controlling the connection of telephones, accounting, etc.; a storage 21 including a contractor information table; and a switchboard 23 for connecting the network 25 to another communication network 27. In case a call is made from the portable telephone 11, the call is connected to the network 25 via the base station 15 and further connected to another portable telephone 13 via the base station 17 under the control of the controller 19. Otherwise, the call is connected to another communication network 27 via the switchboard 23.

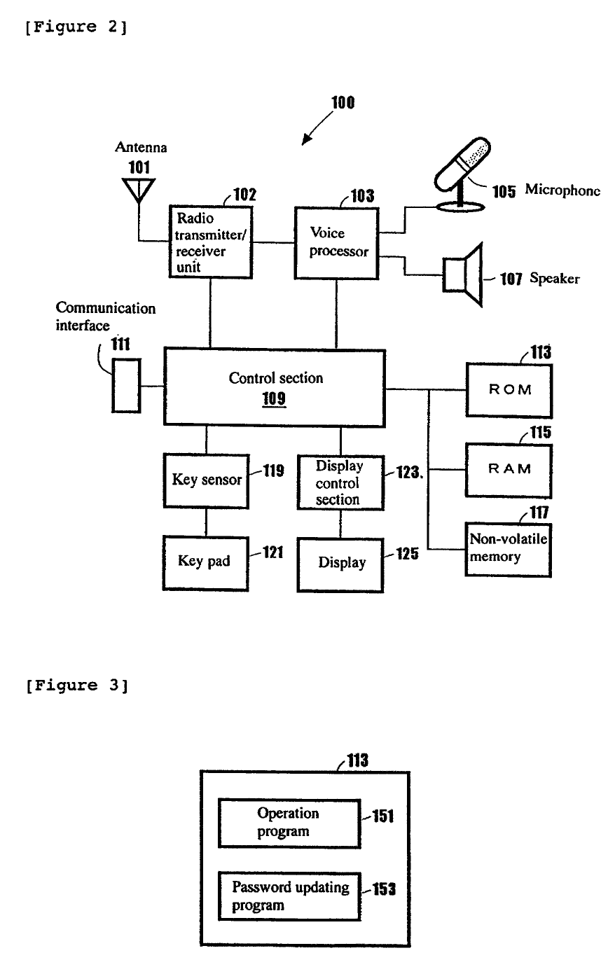

FIG. 2 shows a schematic block diagram of a portable telephone 100 to which the present invention applies. An antenna 101 is used to send/receive radio signals between the base stations 15 and 17. The antenna 101 is connected to a radio transmitter/receiver unit 102. The radio transmitter/receiver unit 102 converts voice data to communication data and vice versa, as well as modulates/demodulates communication data and distinguishes between voice data and control data. The radio transmitter/receiver unit 102 is connected to a voice processor 103 so that voice data is exchanged between them. The voice processor 103 includes an encoder/decoder unit for converting voice data to voice signals and vice versa. The voice processor 103 is connected to a microphone 105 and a speaker 107 that are combined so as to function as an interface between the portable telephone 100 and the operator with use of voices.

The control section 109 is mainly configured by a CPU. The control section 109 controls the operation of the whole portable telephone 100. The control section 109 is connected to a communication interface 111. The communication interface includes an RS232C serial interface connector, which is used for data communication between a telephone and an external device. The control section 109 is connected to the radio transmitter/receiver unit 102 and the voice processor 103 respectively. The control section 109 sends/receives control data to/from the radio transmitter/receiver unit 102 and controls those operations.

The control section 109 is connected to a ROM 113, a RAM 115, and a non-volatile memory 117 respectively. The ROM 113 stores an operation program required to operate the CPU of the control section 109. The program in the ROM 113 is kept as is when the power supply (not illustrated) of the portable telephone 100 is turned off. The RAM 115 is used to store data temporarily, which is to be processed by the CPU. The data in the RAM 115 is erased when the power supply of the portable telephone is turned off.

The non-volatile memory 117 should preferably be a flash memory in which data can be written electrically. The data in the memory 117 is kept as is when the power supply is turned off. The non-volatile memory 117 stores the identification number specific to a telephone, the telephone number, and the password initial value written at a dealer shop when the telephone is purchased. In addition, the non-volatile memory 117 stores the telephone number, various other set data of the telephone registered by the user who purchased it. The information stored in the non-volatile memory 117 can be sent/received to/from an external device via the communication interface 111. The control section 109 is connected to a key pad 121 via a key sensor 119 and further to a display 125 via a display control section 123.

The user uses the key pad 121 to input information required to operate the telephone. The key sensor 119 generates a key code according to an operated key and sends the key code to the control section 109. The display control circuit 123 receives a signal denoting an operation state output from the control section 109, a remote telephone number, etc. and controls the display 125 so as to display the data corresponding to the signal.

Next, a description will be made for a general operation of the portable telephone 100 shown in FIG. 2. When the user purchases the telephone, the operation program is stored in the ROM 113 as described above. In the non-volatile memory 117 are written initial values of set data items, the identification number, and the user's phone number via the communication interface 111. The owner, after purchasing the telephone, operates the key pad 121 to write set data items denoting specific party phone numbers and an easier operation state for the user in the non-volatile memory 117. In addition, the portable telephone 100 can be provided with a removable recording medium (not illustrated). And, it is possible to remove the recording medium after the information stored in the non-volatile memory 117 is written therein, then attach the medium to another portable telephone so that the information is transferred to the non-volatile memory of the object portable telephone.

Hereinafter, a description will be made on the assumption that in case data is exchanged between two portable telephones configured as shown in FIG. 2 respectively via base stations, the portable telephone 11 shown in FIG. 1 makes a call and the portable telephone 13 receives the call. In case the telephone 11 makes a call to the telephone 13, the user inputs the phone number of the telephone 13 directly from the key pad 121 of the telephone 11 or operates the key pad 121 to read the registered phone number from the non-volatile memory 117 into the RAM 115. Then, the user presses a call button on the key pad 121 to make the control section 109 to start the calling. The control section 109 calls both of the identification number and individual phone number (of the telephone 11) from the non-volatile memory 117 into the RAM 115 and sends them to the radio transmitter/receiver unit 102 together with the phone number of the telephone 13 and a communication start code. The carrier is then modulated and those data items are sent to the base station as modulated communication data for calling from the antenna 101.

The base station has a contractor information table in its storage 21. The contractor information table stores the identification number, the phone number, the address, the name, etc. of each telephone and information for identifying its owner. Receiving communication data for calling from the telephone 11, the base station 15 modulates and processes the signal, then sends the data to the controller 19. The controller 19 collates both identification number and phone number of the sending user with the data registered in the contractor information table. And, in case the call from the telephone is decided to be valid, the controller transfers a calling signal to the phone number of the telephone 13.

Receiving communication data for calling from the base station via the antenna 101, the telephone 13 demodulates the data in the radio transmitter/receiver unit 102 and sends the demodulated data to the control section 109. The control section 109, when recognizing that its telephone is called, sends a calling signal to the voice processor so as to generate a calling sound from the speaker 107. The owner of the telephone 13 then operates the key pad 121 so as to send a command to the control section 109 in response to the calling sound. Receiving the command, the control section 109 controls the radio transmitter/receiver unit 102 and the voice processor 103 so as to enable a communication to be made via the microphone 105 and the speaker 107. The voice signal inputted from the microphone 105 is encoded by the voice processor 103 and converted to voice data. The voice data is then sent to the radio transmitter/receiver unit 102, then converted to communication data and modulated. After that, the modulated data is sent to the telephone 11 from the antenna 101 via the base station 17.

In case the receiving user starts communication, the control signal is sent to the base station 17, thereby the controller 19 begins accounting and the accounting information is recorded in the contractor information table of the sending user.

On the other hand, the telephone 11 receives voices and control-related communication data from the base station 15. The communication data received at the antenna 101, then modulated is demodulated by the radio transmitter/receiver unit 102. The control data is sent to the control section 109 and the voice data is sent to the voice processor 103.

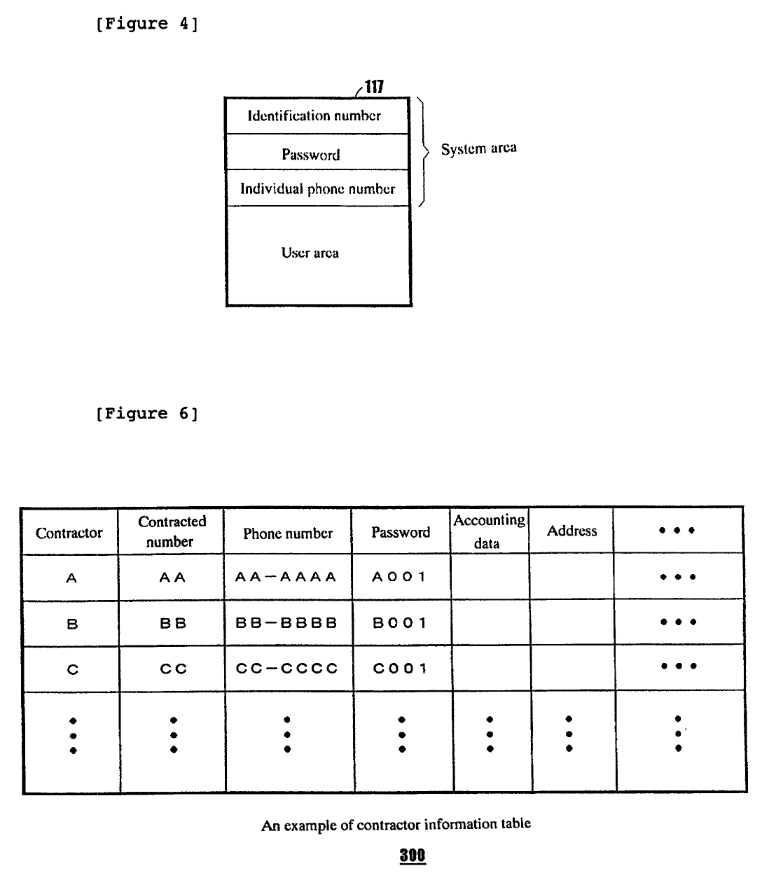

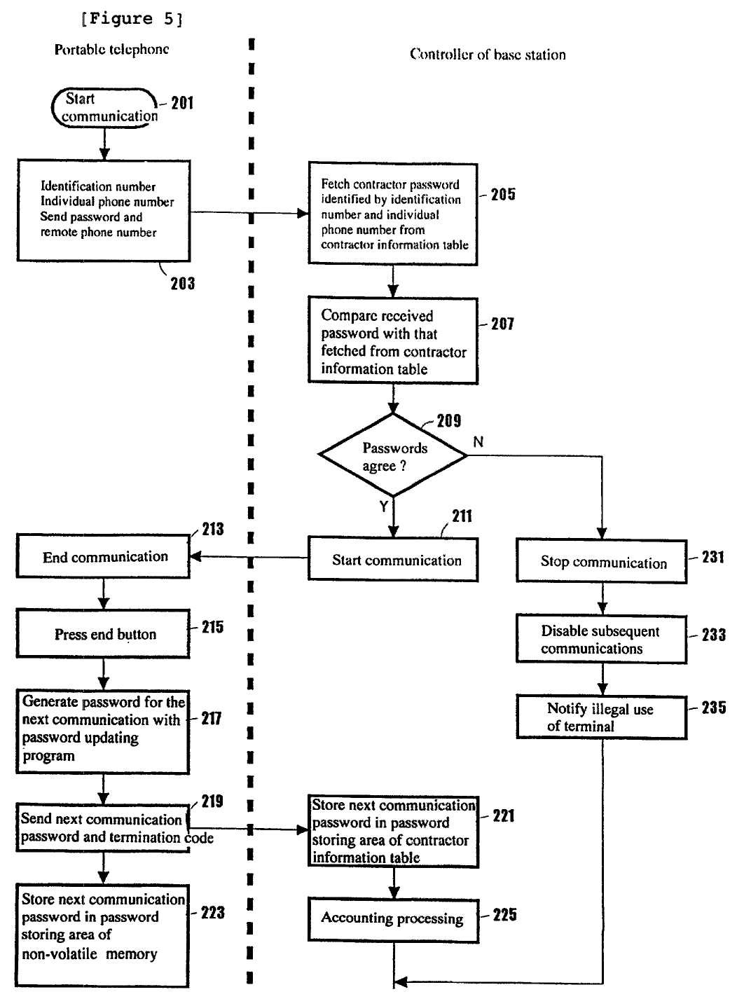

Next, a description will be made for another embodiment in which the present invention applies to the portable telephone 100 shown in FIG. 2 with reference to the flowchart shown in FIG. 5. Upon the application of the present invention, the manufacturer of the telephone has written the operation program 151 and a password updating program 153 in the ROM 13 as shown in FIG. 3. And, the dealer company of the telephone has written the identification number, the password, and the individual phone number in the system area of the non-volatile memory 117 of the telephone as shown in FIG. 4. In the user area are written the phone number, set data items, etc. inputted by the owner. At the sales time, the stored password is an initial value. As to be described later in detail, the password is updated each time a communication is ended according to the present invention. In the storage of the network 25 is stored a contractor information table as shown in FIG. 6.

The contractor information table stores the identification number, phone number, the password, the accounting information, etc. specific to each contractor. At this time, the stored password is still an initial value. As to be described later, the password is updated each time a communication is ended according to the present invention.

Hereinafter, description for the general operations of the telephone 100, which have already been described above, will be omitted or described just simply. In block 201, the user operates the key pad 121 so as to read the remote phone number into the RAM 115. At this time, the operation program 151 reads the identification number, the individual phone number, and the password from the non-volatile memory 117 and stores them in the RAM 115 in block 203. Those data items stored in the RAM 115 as described above are sent as communication data for calling together with a communication start code to the base station 15 of the network 25 via the radio transmitter/receiver unit 102. The storage 21 of the network 25 stores the contractor information table 300 as shown in FIG. 6. In block 205, the controller 19 that has received the communication data for calling reads the corresponding password from the contractor information table 300 according to the identification number and the phone number.

The individual phone number may not be sent necessarily; it can also be searched in the contractor information table according to the identification number. In block 207, the password received from the telephone 11 is compared with the password read from the contractor information table by referencing to the identification number. In block 209, it is determined whether the comparison result is identical or not. In case both passwords are identical, control goes to block 211 so as to enable the communication to be started. The controller 19 then begins counting of the communication time for accounting. To end the communication in block 213, the user presses the end button on the key pad 121 of the portable telephone in block 215. Then, in block 217, control of the control section 109 is passed to the password updating program 153 in response to the pressed end button of the portable telephone 11. The password updating program 153 then generates a new password, which is different from the password (old password) stored in the non-volatile memory 117 at that time. The password updating program 153 then overwrites the new password on the old password stored in the non-volatile memory 117. This new password is used for the next communication.

The password updating program may be any one that can generate a password, which is different from the old password. For example, the program may generate a new password by performing an operation on an old password and a predetermined constant. The program, however, should preferably be able to generate a new password at random. In case a portable telephone is provided with such the means for generating a password at random, it will become difficult for a fraudulent user to use the copy telephone continuously without being found by the true user even when the fraudulent user can steal the updating logic of the password successfully. Such a random password may not necessarily be generated only by software; it may be generated by hardware.

In case a new password is generated in block 217, control of the control section 109 is passed to the operation program 151. In block 219, therefore, the next password and the communication termination code are sent to the base station 15. Although the next password is updated at the end of the communication and sent to the network in this embodiment, the present invention is not limited only to that embodiment; a password, which is different from the password used at the start of the communication, may be generated and sent to the network before the end of the communication.

Receiving the termination code in block 221, the controller 19 ends the communication time counting for accounting and updates the password (old password) in the contractor information table shown in FIG. 6 with the new password received from the telephone 11 at the end of the communication. The telephone 11 then overwrites the new password on the old password stored in the password storing area in the non-volatile memory 117 in block 223. After the processings in blocks 221 and 223 are carried out, the new password (used for the next communication) is stored in both of the non-volatile memory 117 of the telephone 11 and in the contractor information table 300 respectively.

In this embodiment, it will become apparent in the description for blocks in and after 231, which is branched from block 209 shown in FIG. 5 that a true contractor can find an illegal use of a copy telephone manufactured with fraudulent use of an identification number and a password that are stolen. As described in blocks 221 and 223, disagreement between the password sent from the portable telephone 11 in block 209 and the password stored in the contractor information table 300 while the identification number is the same is against the presumption that both of the portable telephone 11 and the network must have the new password updated at the end of the last communication with respect to the identification number and the phone number.

Concretely, except for a technical write error to occur in the non-volatile memory 117 and in the contractor information table 300, the password sent from the telephone 11 this time is different from the password updated at the end of the last communication. In case the last updated password is stolen and it is set together with the identification number and the phone number in a copy telephone, which is used fraudulently, then the updated password is stored in the contractor information table at the end of the communication. And, in case the true contractor attempts to make a call from the telephone 11 later, the password stored in the non-volatile memory 117 is different from that stored in the contractor information table. The controller 19 thus stops the communication in block 231 even when the call is made by the true contractor (user).

Furthermore, the controller 19 inhibits the use of the portable telephone having the identification number completely in block 233. Consequently, it is impossible to use even the copy telephone in which the stolen password is set after that. In block 235, the controller 19 notifies the user of the fact that the portable telephone that is making a call is disabled due to a detected illegal use of the telephone according to the stolen password. Due to this notification, the true owner of the portable telephone can know the fraudulent use of the password, thereby getting in contact with the communication service provider so as to initialize the password and the identification number and restart the use of the telephone.

Furthermore, it is also expected that the copy telephone that has used a password fraudulently does not update the password at the end of the communication and sends the old password to the network. In such a case, the controller 19 can take a proper countermeasure; the controller stops the communication in case the password received at the end of the last communication does not agree to the password used at the start of the communication. In case the controller does not stop the communication, the old password used by the true contractor for a communication is updated at the end of the communication. Hereinafter, therefore, the fraudulent user cannot use the telephone.

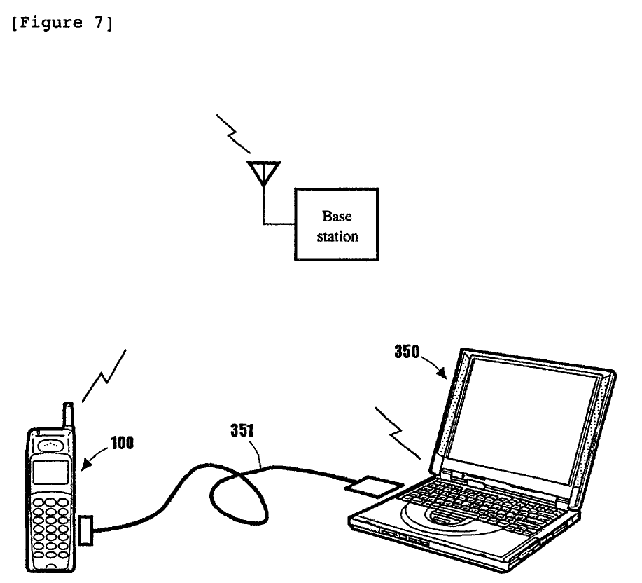

Another embodiment of the present invention is a system that enables a plurality of portable telephones or a plurality of such communication terminals as PDAs, lap-top PCs, etc. provided with communication functions respectively to be used under one contract. As described in the prior art technique, only one communication terminal is usable under one contract. Assume now that in FIG. 7, the user contracts for the portable telephone 100 described with reference to FIGS. 2 and 5, so that the user is assigned with an identification number, a phone number, and a password. In this embodiment of the present invention, in case one and the same user uses a portable PC 350 provided with the same communication functions as those of the portable telephone 100, there is no need for the user to make another contract for the portable PC.

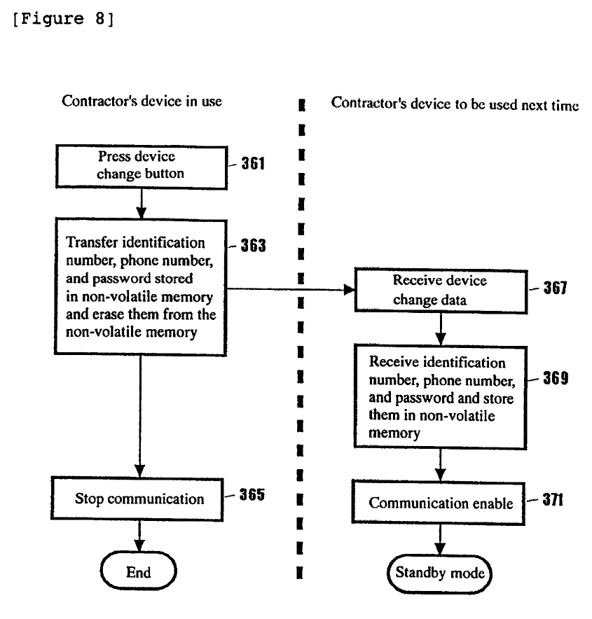

Next, a description will be made for a procedure that changes a usable device from the portable telephone 100 to the portable PC 350 selectively with reference to the flowchart shown in FIG. 8. The portable telephone 100 in this embodiment is provided with a device change button on the key pad 121. The portable PC 350 is a general personal computer except for that the PC 350 is provided with the same communication functions as those of the portable telephone described with reference to the block diagram shown in FIG. 2. Detailed description for the PC 350 will thus be omitted here. Concretely, the portable PC 350 is provided with a keyboard; a display; and such a communication port (equivalent to the communication interface 111 shown in FIG. 2) as the RS232C as external devices and a CPU (equivalent to the control section 109 shown in FIG. 2); a main memory (equivalent to the RAM 115 shown in FIG. 2); an HDD (equivalent to the ROM 113 shown in FIG. 2); a flash memory (equivalent to the non-volatile memory 117 shown in FIG. 2); and an FDD as built-in devices. The data processed in the CPU can be stored in the HDD and/or transferred to an external device via the communication port. The CPU or flash memory can store data received from an external device.

At first, the RS232C communication interface of the portable telephone is connected to the RS232C communication port of the portable PC via a serial cable 351. In block 361, the user presses the device change button of the portable telephone. In block 363, the user transfers the identification number, the phone number, the password, etc. stored in the non-volatile memory 117 to the flash memory of the portable PC 350 via the cable 351. Such data items as the identification number, etc. are required to change devices. At the same time, the user erases those data items stored in the non-volatile memory 117 of the portable telephone 100. The data required to change devices may be transferred via a non-volatile recording medium without using the communication port. The portable telephone 100, when the identification number, etc. are erased, is disabled (block 365).

On the other hand, the portable PC 350 receives the device change data in block 367 and stores the data in the flash memory of the portable PC 350 in block 369. After that, the communication functions of the portable PC 350 become available in block 371. In this state, the portable PC communicates with the base station in the procedure described with reference to FIG. 5, thereby updating the password at the end of the communication. In this embodiment, therefore, even when the device change data of the portable telephone 100 is stolen and transferred to another communication terminal, the true contractor can receive a notice of the illegal use and know the appearance of a copy terminal when attempting a communication from the portable PC 350, since the password is already updated due to the access of the fraudulent user. And, even when the fraudulent user avoids updating the password at the end of a talking or communication, the communication service provider stops the communication due to the use of the same password as described above. Otherwise, the password is updated at the end of the next communication by the true user, thereby the fraudulent user cannot continue the use of the copy terminal any longer.

Because a plurality of communication terminals are used under one contract such way, this embodiment enables device change data to be transferred and a plurality of portable telephones to be used with a plurality of frequencies under one contract in case, for example, a portable is used over countries where different frequencies are used. The embodiments described above are just examples and the present invention should not be limited only to those embodiment. The scope of the present invention, therefore, is to be determined solely by the claims.

Advantages of the Invention

According to the present invention, therefore, it is possible to provide a communication method and a communication terminal that enable a true contractor to easily recognize an illegal use of a copy terminal manufactured with a stolen password when beginning a communication with a network provided with a storage that stores the identification information and the password of the contractor from a communication terminal provided with a non-volatile memory that stores the identification information and the password thereof. In addition, it is possible to provide a communication method and a communication terminal that can find and prevent an illegal use of a copy terminal manufactured with a stolen password easily even in case the true user is enabled to use a plurality of communication terminals selectively under one contract.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after either or both of the following a) conversion to another language, code or notation; b) reproduction in a different material form.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A method comprising:
communicating with a network from a communication terminal provided with a nonvolatile memory that stores identification information and a password and enabled to communicate with said network after said identification information and said password are identified, including the steps of:
(a) sending said identification information and said password stored in said nonvolatile memory to said network at a start of a communication;
(b) generating another password that is different from said password sent in said step (a) after said communication is started;
(c) storing said generated password in said nonvolatile memory; and
(d) sending said generated password to said network before said communication started in said step (a) is ended.

2. The method according to claim 1, wherein sending of said generated password in said step (d) is done at the end of the communication started in said step (a).

3. A method comprising:
communicating with a network from a communication terminal provided with a nonvolatile memory that stores identification information and a password and enabled to communicate with said network after said identification information and said password are identified, said network being provided with a storage that stores said identification information and said password, including the steps of:
(a) receiving said identification information and said password stored in said nonvolatile memory at a start of a communication;
(b) comparing said identification information and said password received in said step (a) with said identification information and said password stored in said storage respectively;
(c) enabling said communication terminal to communicate with said network in response to the result of said comparison in said step (b);
(d) receiving another password that is different from said password received in said step (a) before said communication enabled in said step (c) is ended; and
(e) storing said password received in said step (d) in said storage.

4. A method according to claim 3, wherein said method further includes a step of:
stopping communication of said communication terminal in case said password received in said step (d) corresponds to said password received at the start of said communication in said step (a).

5. The method according to claim 3, wherein said password is received in said step (d) when said communication enabled in said step (c) is ended.

6. A method comprising:
communicating with a network from a communication terminal provided with a nonvolatile memory that stores identification information and a password and enabled to communicate with said network after said identification information and said password are identified, said network being provided with a storage that stores said identification information and said password, including the steps of:
(a) sending said identification information and said password stored in said nonvolatile memory to said network at a start of a communication;
(b) comparing said identification information and said password sent in said step (a) with said identification information and said password stored in said storage respectively;
(c) enabling said communication terminal to communicate with said network in response to the result of said comparison in said step (b);
(d) generating another password that is different from said password sent in said step (a) after said communication is started; and
(e) storing said generated password in said nonvolatile memory;
(f) sending said generated password to said network before said communication enabled in said step (c) is ended; and
(g) storing said password sent in said step (f) in said storage.

7. A method comprising:
communicating with a network from a first communication terminal provided with a first nonvolatile memory that stores identification information and a password and enabled to communicate with said network after said identification information and said password are identified and from a second communication terminal provided with a second nonvolatile memory and enabled to communicate with said network after said identification information and said password are identified, including the steps of:
(a) storing said identification information and said password stored in said first nonvolatile memory in said second nonvolatile memory;
(b) inhibiting the use of said first communication terminal;
(c) sending said identification information and said password stored in said second nonvolatile memory to said network at a start of said communication;
(d) generating another password that is different from said password sent in said step (c) after said communication is started;
(e) storing said generated password in said second nonvolatile memory; and
(f) sending said generated password to said network before said communication started in said step (c) is ended.

8. A method comprising:
communicating with a network from a first communication terminal provided with a first nonvolatile memory that stores identification information and a password and enabled to communicate with said network after said identification information and said password are identified and from a second communication terminal provided with a second nonvolatile memory and enabled to communicate with said network after said identification information and said password are identified, said network being provided with a storage that stores said identification information and said password, including the steps of:
(a) storing said identification information and said stored in said first nonvolatile memory in said second nonvolatile memory;
(b) inhibiting the use of said first communication terminal;
(c) sending said identification information and said password stored in said second nonvolatile memory to said network at a start of said communication;
(d) comparing said identification information and said password sent in said step (c) with said identification information and said password stored in said storage respectively;
(e) enabling said communication terminal to start said communication in response to the result of said comparison in said step (d);
(f) generating another password that is different from said password sent in said step (c) after said communication is started;
(g) storing said generated password in said second nonvolatile memory; and
(h) sending said generated password to said network before said communication enabled in said step (e) is ended; and
(i) storing said password sent in said step (h) in said storage.

9. The method according to claim 1, wherein said another password is generated at random.

10. A communication terminal enabled to communicate with a network after identification information and password are identified, said terminal including:
a nonvolatile memory enabled to store said identification information and said password;
a unit for generating another password that is different from said password sent at a start of said communication; and
a unit for sending said identification information and said password stored in said nonvolatile memory to said network at a start of said communication, sending said generated password to said network before said started communication is ended, and storing said generated password in said nonvolatile memory.

11. The communication terminal according to claim 10, wherein said unit for generating said another password at random generates the password at random.

12. The communication terminal according to claim 10, wherein said terminal further includes:
a port for sending said identification information and said password stored in said nonvolatile memory to external or receiving them from external.

13. The communication terminal according to claim 10, wherein said terminal can also include a removable storage medium that can store said identification information and said password stored in said nonvolatile memory.

14. A network apparatus for enabling the communication terminal according to claim 10, to start a communication by identifying identification information and a password of said terminal, said apparatus including:
a storage that stores said identification information of said communication terminal and a password corresponding to said identification information; and
a controller for receiving said identification information and said password from said communication terminal at a start of said communication, then comparing said identification information and said password with those stored in said storage, thereby enabling said communication terminal to start said communication according to the result of said comparison, and receiving another password that is different from said password from said communication terminal before said started communication is ended so as to store said received password in said storage.

15. An article of manufacture comprising a computer usable medium having computer readable program code means embodied therein for causing communication, the computer readable program code means in said article of manufacture comprising computer readable program code means for causing a computer to effect the steps of claim 1.

16. An article of manufacture comprising a computer usable medium having computer readable program code means embodied therein for causing communication, the computer readable program code means in said article of manufacture comprising computer readable program code means for causing a computer to effect the steps of claim 3.

17. An article of manufacture comprising a computer usable medium having computer readable program code means embodied therein for causing communication, the computer readable program code means in said article of manufacture comprising computer readable program code means for causing a computer to effect the steps of claim 6.

18. An article of manufacture comprising a computer usable medium having computer readable program code means embodied therein for causing communication, the computer readable program code means in said article of manufacture comprising computer readable program code means for causing a computer to effect the steps of claim 7.

19. An article of manufacture comprising a computer usable medium having computer readable program code means embodied therein for causing communication, the computer readable program code means in said article of manufacture comprising computer readable program code means for causing a computer to effect the steps of claim 8.

20. A computer program product as recited in claim B1, the computer readable program code means in said computer program product further comprising computer readable program code means for causing a computer to effect terminal of claim 10.

21. A computer program product as recited in claim B1, the computer readable program code means in said computer program product further comprising computer readable program code means for causing a computer to effect the apparatus of claim 14.
